(19) United States
(12) Patent Application Publication
(10) Pub. No.: US 2014/0173033 A1
(43) Pub. Date: Jun. 19, 2014

(54) SYSTEM, METHOD AND COMPUTER PROGRAM PRODUCT FOR PROCESSING DATA IN A DYNAMIC AND GENERIC MANNER

(71) Applicant: salesforce.com, inc., San Francisco, CA (US)

(72) Inventor: Alexander Stephen McClintock, Corona Del Mar, CA (US)

(73) Assignee: salesforce.com, inc., San Francisco, CA (US)

(21) Appl. No.: 14/052,636

(22) Filed: Oct. 11, 2013

Related U.S. Application Data
(60) Provisional application No. 61/738,198, filed on Dec. 17, 2012.

(51) Int. Cl. H04L 12/24

(52) U.S. Cl. CPC H04L 41/0246
USPC 709/217

(57) ABSTRACT

In accordance with embodiments, there are provided mechanisms and methods for processing data in a dynamic and generic manner. These mechanisms and methods for processing data in a dynamic and generic manner can enable improved system efficiency, decreased resource and time usage, enhanced cost savings, etc.

### CLAIM OF PRIORITY

This application claims the benefit of U.S. Provisional Patent Application No. 61/738,198, entitled “Dynamic and Generic Callouts,” by Alex McClintock, filed Dec. 17, 2012 (Attorney Docket No. 1096PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### HELD OF THE INVENTION

One or more implementations relate generally to performing callouts, and more particularly to processing data received in response to a callout.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Many current systems request and obtain data from various sources on a regular basis. Unfortunately, techniques for processing such received data have been associated with various limitations. Just by way of example, many systems need to implement system classes and pages specific to each callout for data that they make. Accordingly, it is desirable to provide techniques for processing data in a dynamic and generic manner.

### BRIEF SUMMARY

In accordance with embodiments, there are provided mechanisms and methods for processing data in a dynamic and generic manner. These mechanisms and methods for processing data in a dynamic and generic manner can enable improved system efficiency, decreased resource and time usage, enhanced cost savings, etc.

In an embodiment and by way of example, a method for processing data in a dynamic and generic manner is provided. In one embodiment, a request for data is sent. Additionally, the data is received in response to the request. Further, the received data is processed in a dynamic and generic manner.

While one or more implementations and techniques are described with reference to an embodiment in which processing data in a dynamic and generic manner is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for processing data in a dynamic and generic manner, in accordance with one embodiment;

FIG. 2 illustrates a method for implementing dynamic and generic callouts, in accordance with another embodiment;

FIG. 3 illustrates a block diagram of an example of an environment wherein an on-demand database system might be used; and

FIG. 4 illustrates a block diagram of an embodiment of elements of FIG. 3 and various possible interconnections between these elements.

### DETAILED DESCRIPTION

### General Overview

Systems and methods are provided for processing data in a dynamic and generic manner.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for processing data in a dynamic and generic manner will be described with reference to example embodiments.

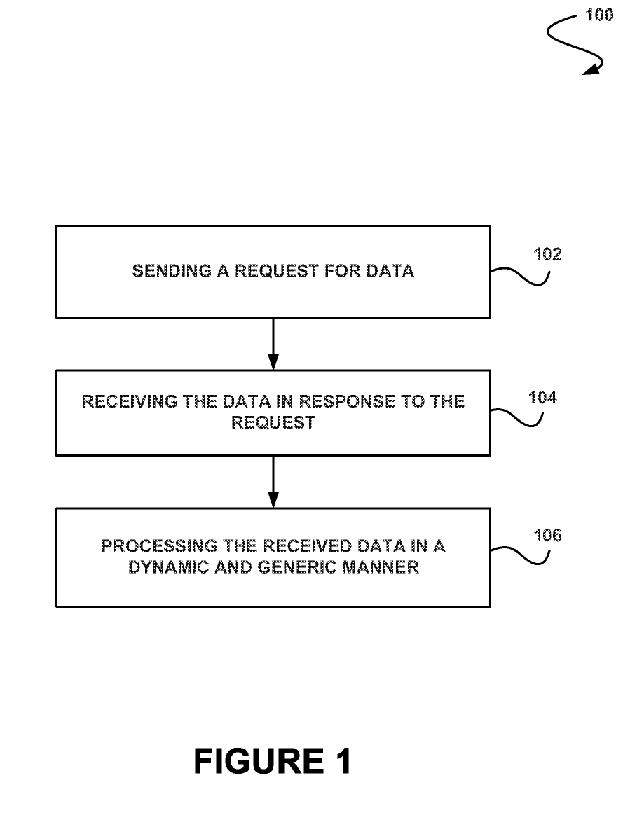

FIG. 1 illustrates a method 100 for processing data in a dynamic and generic manner, in accordance with one embodiment. As shown in operation 102, a request for data is sent. In one embodiment, the request for data may be sent by a system. For example, the request for data may be sent by a multi-tenant on-demand database system. In another embodiment, the request for data may be sent to a system other than the system sending the request. For example, the request for data may be sent to a system containing the data (e.g., database, a web services system, etc.) from a system that does not contain the data.

Additionally, in one embodiment, the request for data may include a callout. For example, the request for data may include a call to an external system. In another embodiment, the request for data may include a call to an external web service. In yet another embodiment, the request for data may include a hypertext transfer protocol (HTTP) request to a network address. In still another embodiment, the intended recipient of the request may be authorized before the request is sent.

Further, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Further still, as shown in operation 104, the data is received in response to the request. In one embodiment, the data may be received from the system to which the request was sent. For example, a first system that received the request may send the data from the first system to a second system, where the request originated from the second system. In another embodiment, the data may be received in a predetermined structure. For example, the data may be received in an extensible markup language (XML) structure.

Also, in one embodiment, the received data may have a variable format. For example, the received data may have a format different from other data received by the system in response to other requests sent by the system. In another example, the received data may have a variable organization, a variable layout, a variable format, variable fields, etc. when compared to other received data. In another embodiment, an object may be created within the system in response to receiving the data. For example, an object may be created within the system, where such object is to be correlated with the data received in response to the request.

In addition, as shown in operation 106, the received data is processed in a dynamic and generic manner. In one embodiment, the received data may be processed by the system that receives the data. In another embodiment, processing the received data in a dynamic and generic manner may include generically parsing the received data. For example, a structure may be associated with the received data, and the structure of the received data may be dynamically parsed by the system.

Furthermore, in one embodiment, the received data may be parsed by a class defined within a system. In another embodiment, the received data may be parsed using one or more recursive calls. For example, iteration may be performed through a system provided datalist using an “<apex:repeat>” component. Of course, however, the received data may be parsed in any manner that is performed dynamically (e.g., responsive to the structure of the received data, etc.).

Further still, in one embodiment, processing the received data in a dynamic and generic manner may include generically rendering the received data. For example, the received data may be dynamically rendered utilizing a framework of the system. In another embodiment, the received data may be generically rendered by performing one or more iterations in association with the received data. For example, the system may iterate through a list of field names while processing the received data (e.g., to identify one or more fields included within the received data, etc.). In another example, data within the identified fields may then be correlated (e.g., mapped, etc.) to an object within the system (e.g., an object created within the system to correspond to and store the received data, etc.). In this way, a request may be made to a service at a single system, where such service may return a variable response.

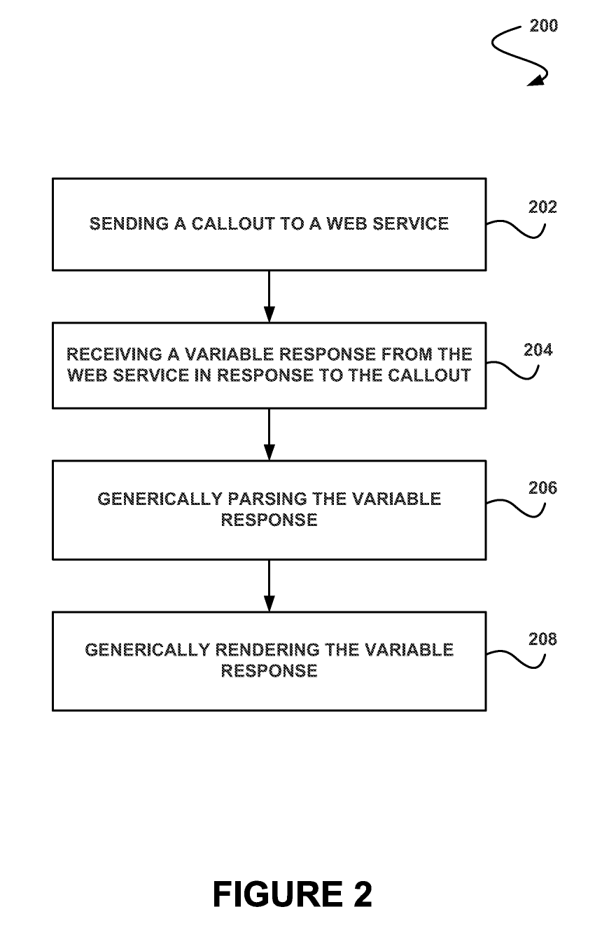

FIG. 2 illustrates a method 200 for implementing dynamic and generic callouts, in accordance with another embodiment. As an option, the method 200 may be carried out in the context of the functionality of FIG. 1. Of course, however, the method 200 may be carried out in any desired environment. The aforementioned definitions may apply during the present description.

As shown in operation 202, a callout is sent to a web service. In one embodiment, the callout may be sent from a system (e.g., a multi-tenant on-demand database system, etc.). In another embodiment, the web service may include a web-based service that provides data in response to a request. In yet another embodiment, the web service may include a database, a server, etc. In still another embodiment, the callout may include a request for data. For example, the callout may include a request for data needed by the system making the callout. In another embodiment, the callout may be performed utilizing an HTTP request. In yet another embodiment, one or more security features (e.g., security credentials, a security header, etc.) may be added to the callout.

Additionally, as shown in operation 204, a variable response is received from the web service in response to the callout. In one embodiment, the variable response may include the data requested by the callout. In another embodiment, the variable response may have a predetermined structure. For example, the variable response may have an XML structure. In yet another embodiment, the variable response may have contents that vary when compared to other responses. For example, the variable response may have one or more fields and/or formats that are unique to that response when compared to other responses (e.g., responses received from the web service, etc.).

Further, as shown in operation 206, the variable response is generically parsed. In one embodiment, generically parsing the variable response may include dynamically parsing the structure of the variable response (e.g., the XML structure of the variable response, etc.). In another embodiment, the variable response may be generically parsed by a class defined within the system. In yet another embodiment, the variable response may be parsed using one or more recursive calls.

Further still, as shown in operation 208, the variable response is generically rendered. In one embodiment, generically rendering the variable response may include dynamically rendering the variable response using a framework of the system. In another embodiment, generically rendering the variable response may include iterating through one or more elements associated with the variable response. For example, the system may iterate through a list of field names associated with the variable response (e.g., in order to determine one or more matching fields within the variable response when performing correlating or mapping, etc.). In yet another embodiment, when one or more fields within the variable response have been determined, data from the fields may be mapped to corresponding fields of an object created within the system. In another embodiment, data from one or more fields may be altered (e.g., updated, corrected, etc.) before being mapped to the corresponding fields of the system object.

Also, in one embodiment, one or more system classes may be created and used for constructing requests, invoking callouts, and processing responses into objects which can be read by the system. In another embodiment, one or more system pages may be created to demonstrate embedding and display of the received variable response data. In yet another embodiment, one or more components of the system framework may be created to display data from the received variable response and for reusability across various system framework pages corresponding to callouts.

In this way, a callout may be made to a single web service, where the single web service may return a variable response. The variable response structure may then be generically parsed by a class of the receiving system and then may be generically rendered by the system framework by iterating through a list of field names using these as a key for a map (e.g., to retrieve the field value, etc.).

Also, in one embodiment, a single system class and system framework component may perform the callout request to a single endpoint (e.g., the web service, etc.). The class may include response parsing and dynamic display. However, separate system framework pages may be used to display the core system framework component on different page layouts for different objects. In this way, the cost of developing a separate integration for every callout to a target system may be avoided.

### System Overview

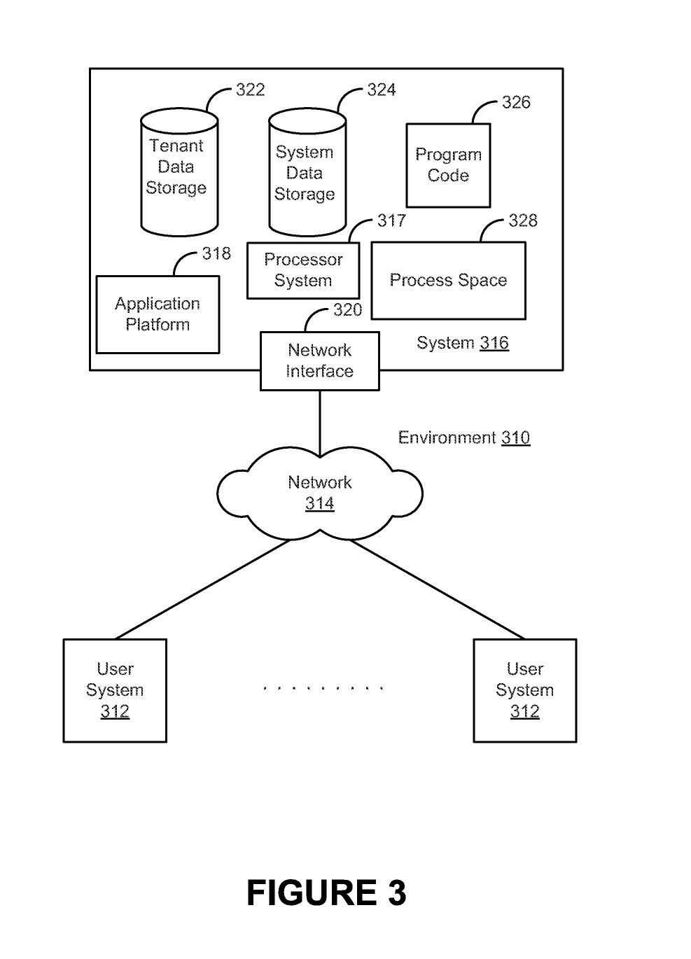

FIG. 3 illustrates a block diagram of an environment 310 wherein an on-demand database system might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

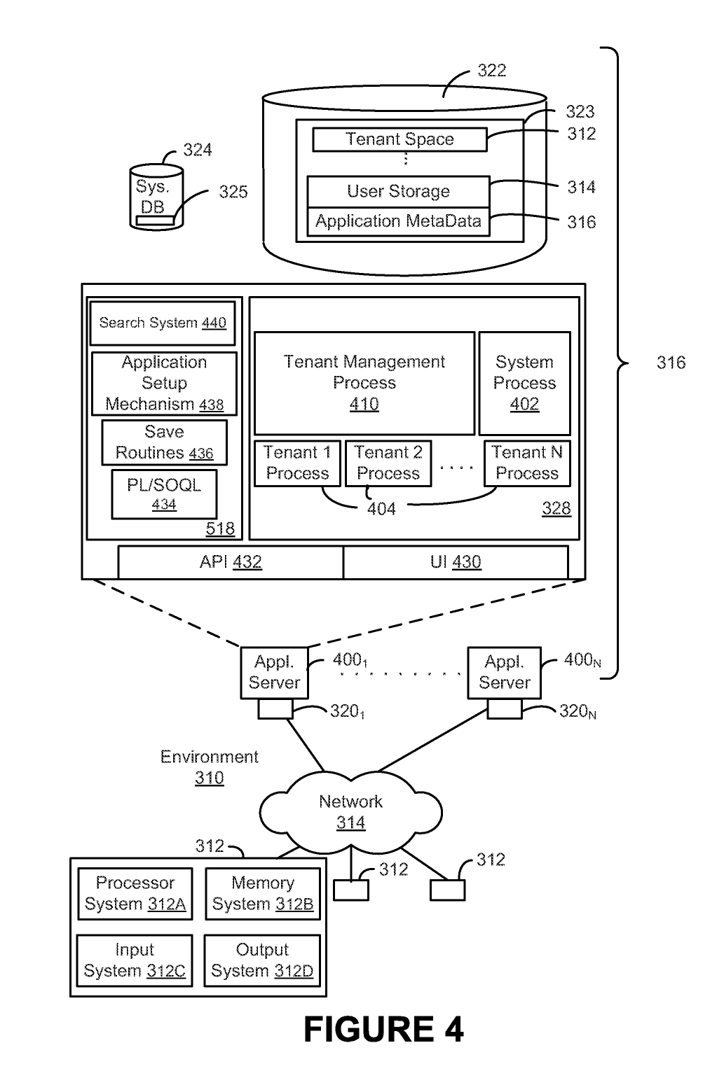

Environment 310 is an environment in which an on-demand database system exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 4) user systems 312 might interact via a network 314 with an on-demand database system, which is system 316.

An on-demand database system, such as system 316, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database system 316 may include an application platform 318 that enables creation, managing and executing one or more applications developed by the provider of the on-demand database system, users accessing the on-demand database system via user systems 312, or third party application developers accessing the on-demand database system via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where inure than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, JAVA™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400i might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might he organization-wide data shared or accessible by a plurality of users or all of the users for a given organization that is a tenant. Thus, there might be some data structures managed by system 316 that are allocated at the tenant level while other data structures might he managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising;
computer code for sending a request for data:
computer code for receiving the data in response to the request; and
computer code for processing the received data in a dynamic and generic manner.

2. The computer program product of claim 1, wherein the request for data is sent by a multi-tenant on-demand database system.

3. The computer program product of claim 1, wherein the request for data includes a callout.

4. The computer program product of claim 1, wherein the request for data includes a call to an external system.

5. The computer program product of claim 1, wherein the request for data includes a call to an external web service.

6. The computer program product of claim 1, wherein e request for data includes a hypertext transfer protocol (HTTP) request to a network address.

7. The computer program product of claim 1, wherein the data is received in an extensible markup language (XML) structure.

8. The computer program product of claim 1, wherein the received data is received by a system and has a format different from other data received by the system in response to other requests sent by the system.

9. The computer program product of claim 1, wherein the received data has one or more of a variable organization, a variable layout, a variable format, and variable fields when compared to other received data.

10. The computer program product of claim 1, wherein an object is created within the system in response to receiving the data.

11. The computer program product of claim 10, wherein the object is to be correlated with the data received in response to the request.

12. The computer program product of claim 1, wherein processing the received data in a dynamic and generic manner includes generically parsing the received data.

13. The computer program product of claim 1, wherein a system receives the data, a structure is associated with the received data, and the structure of the received data is dynamically parsed by the system.

14. The computer program product of claim 1, wherein the received data is parsed by a class defined within a system.

15. The computer program product of claim 1, wherein processing the received data in a dynamic and generic manner includes generically rendering the received data.

16. The computer program product of claim 15, wherein the received data is generically rendered by performing one or more iterations in association with the received data.

17. The computer program product of claim 16, wherein a system receives the data, and the system iterates through a list of field names while processing the received data to identify one or more fields included within the received data.

18. The computer program product of claim 17, wherein data within the identified fields is correlated to an object created within the system to correspond to and store the received data.

19. A method, comprising:
sending a request for data;
receiving the data in response to the request; and
processing the received data in a dynamic and generic manner.

20. An apparatus, comprising:
a processor for:
sending a request for data;
receiving the data in response to the request; and
processing the received data in a dynamic and generic manner.

21. A method for transmitting code for use in a multi-tenant database system on a transmission medium, the method comprising:
transmitting code for sending a request for data;
transmitting code for receiving the data in response to the request; and
transmitting code for processing the received data in a dynamic and generic manner.
